(19) United States
(12) Patent Application Publication
(10) Pub. No.: US 2021/0407485 A1
(43) Pub. Date: Dec. 30, 2021

(54) Variable wind guitar pickup

(71) Applicant: ROBERT E. CONWAY, JR., INDPLS, IN (US)

(72) Inventor: ROBERT E. CONWAY, JR., INDPLS, IN (US)

(21) Appl. No.: 16/912,405

(22) Filed: Jun. 25, 2020

(51) Int. Cl. G10H 3/18

(52) U.S. Cl. CPC G10H 3/181

(57) ABSTRACT

A process for winding guitar pickups in which I tap in on different places on the bobbins giving the player the ability to change the number of windings and sound with switches.

### 1. BACKGROUND OF THE INVENTION

Today's electric guitars use single coil and double coil pickups to produce sound. There limited to one sound. Some guitars with more than one pickup combine two pickups or switch them in and out of phase or reverse the wires to produce different sounds. I had the idea of winding the bobbins and tapping into numerous places and using a switch to control it. This gives you a variety of sounds out of one pickup.

### 2. BRIEF SUMMARY OF THE INVENTION

As described in the background section, my pickups are the only ones that change the sound by changing the number of windings.

### 3. BRIEF DESCRIPTION OF DRAWINGS

FIG. 1 Schematic wiring diagram showing a double coil variable wind pickup wired to two switches.

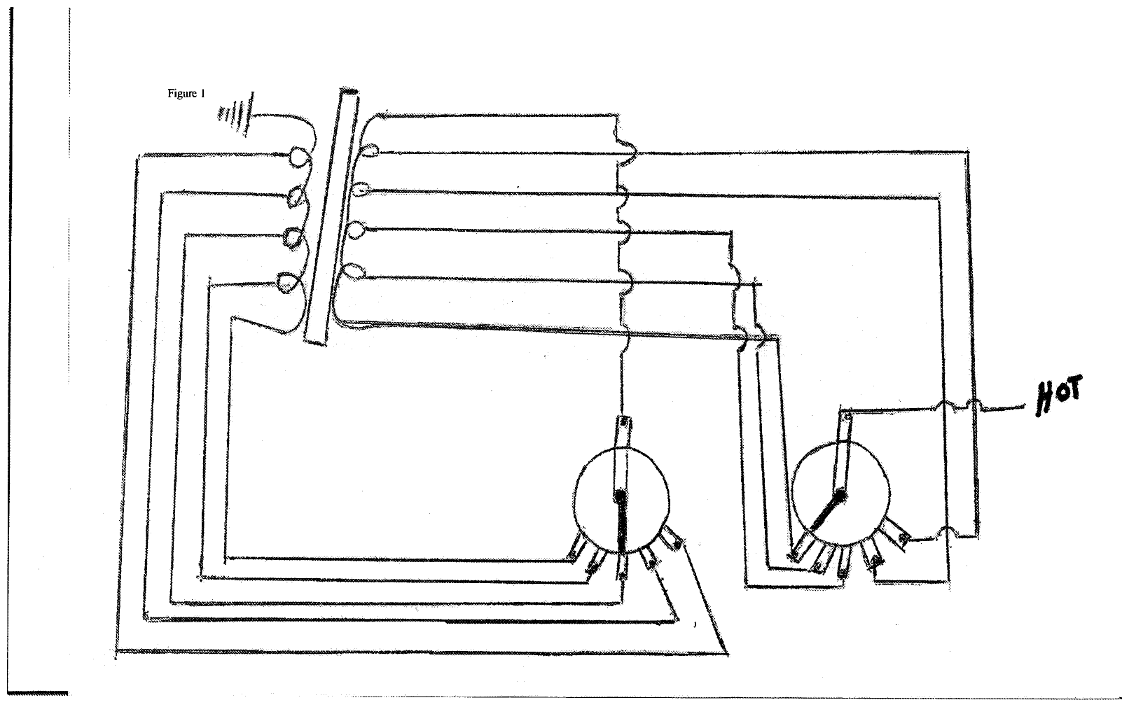

FIG. 2 A picture showing the top and bottom of a single coil variable wind guitar pickup with shielded wire and a switch connected.

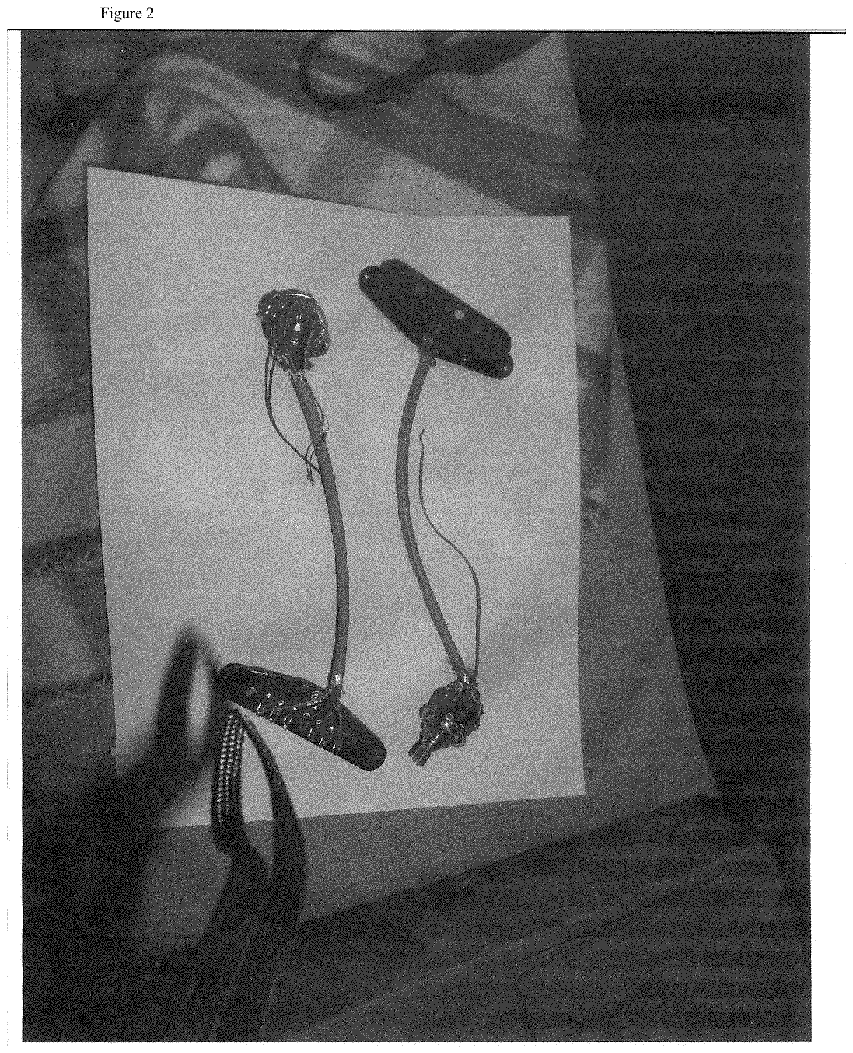

### 4. DETAILED DESCRIPTION OF THE INVENTION

I made a special winder for making my pickups. I make single coil or double coil humbucker pickups. I start by winding a certain number of winds for the first setting then that's connected to a terminal board. I then I add another certain number of winds on top of that and that is setting number two. My current single coil pickups have six settings controlled by a six way switch. My current double coils, or humbuckers have five settings on each coil controlled by two five way switches, which gives them 25 different sounds. Others pickups change the sound by switching coals in and out of phase. No one changes the number of windings. My pickups come with switches and install in the guitar easily.

The claimed invention is a process for making variable wind guitar pickups.

I. This process is used to make single coil guitar pickups that are wound with multiple taping points, on the winds of the pickup coils, to connect into a selector switch.

II. This process is also used for multiple tap points on double coil (humbucker) pickups. (on both bobbins).

III. I also use terminal boards to attach the pickup coil wire to the large wire. Other pickup makers solder the two wires together and tape them to the side.
